(19) United States
(12) Patent Application Publication
(10) Pub. No.: US 2009/0152069 A1
(43) Pub. Date: Jun. 18, 2009

(54) Pressure Plate Assembly

(75) Inventors: Andreas Gebauer, Troy, MI (US); Jeff Gielniak, Royal Oak, MI (US); Charles Booth, Hazel Park, MI (US)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/337,843

(22) Filed: Dec. 18, 2008

Related U.S. Application Data
(60) Provisional application No. 61/008,041, filed on Dec. 18, 2007.

(30) Foreign Application Priority Data
Nov. 5, 2008 (DE) 10 2008 055 964.4

(51) Int. Cl. F16D 13/00

(52) U.S. Cl. 192/89.2

(57) ABSTRACT

A pressure plate assembly for a friction clutch with automatic wear compensation, including a housing which can be attached to a flywheel for rotation in common; a pressure plate installed in the housing and movable axially with respect to the housing; and an energy storage device supported against the housing and the pressure plate and exerting a force along a support path between the energy storage device and the pressure plate. A wear take-up device installed in the support path includes a wear take-up element which is preloaded to move in a wear take-up direction. An anti-reset device includes at least one clamping element which can be blocked to generate clamping contact with the wear take-up element, thereby preventing movement of the wear take-up element relative to the pressure plate in a direction opposite to the wear take-up direction.

### RELATED APPLICATIONS

This application claims priority from U.S. Provisional Patent Application Ser. No. 61/008,041 which was filed on Dec. 18, 2007.

### BACKGROUND OF THE INVENTION

1. Field of the Invention

The present invention pertains to a pressure plate assembly, especially for a motor vehicle friction clutch with automatic wear compensation.

2. Description of the Related Art

A known pressure plate assembly includes a housing which can be attached to a flywheel for rotation in common; a pressure plate installed in the housing and movable axially with respect to the housing; an energy storage device supported against the housing and the pressure plate and exerting a force along a support path between the energy storage device and one of the housing and the pressure plate; and a wear take-up device installed in the support path, including a wear take-up element which is preloaded to move in a wear take-up direction.

In pressure plate assemblies of this type, the wear take-up device with, for example, one or two ring-like take-up elements is located between the pressure plate and an energy-storage device, which is designed as a diaphragm spring. The energy-storage device thus acts on the pressure plate by way of the one or more take-up rings. When wear occurs, at least one of these take-up rings can rotate in the wear take-up device with respect to the pressure plate. The ring has ramp surface areas by which it slides along complementary ramp surface areas on the other take-up ring or on the pressure plate, thus shifting the contact area on the pressure plate for the energy-storage device by an amount equivalent to the wear which has occurred and been detected. One or more springs preload the rotatable take-up ring; that is, they try to rotate it in the direction which serves to compensate for wear. The axial load exerted by the energy-storage device, however, introduces a force component acting basically in the circumferential direction, which opposes movement in the wear take-up direction. Under unfavorable circumstances, such as when very severe vibrations or impacts occur, this force component can have the effect of rotating a take-up ring in the direction opposite that of the preload which tries to rotate it in the wear take-up direction, as a result of which the previous process of wear take-up is at least partially reversed. To deal with this problem, it is possible to keep the angle of the ramp surface areas very shallow with respect to a plane orthogonal to the axis of rotation, so that the forces acting in the circumferential direction, i.e., the forces generated by the action of the energy-storage device, are correspondingly low. As a result of this flat design of the ramp surface areas, however, comparatively large amounts of wear cannot be completely compensated or at least cannot be adequately compensated in a single take-up process.

### SUMMARY OF THE INVENTION

It is therefore an object of the present invention to provide a pressure plate assembly, especially for a motor vehicle friction clutch with automatic wear take-up, in which the unwanted reverse movement of a component which shifts to take up wear can be reliably prevented.

According to the invention, an anti-reset arrangement is assigned to at least one take-up element preloaded to move in the wear take-up direction. The anti-reset arrangement includes at least one wedge-type clamp element or rolling clamp element, which can be blocked to generate clamping contact with the wear take-up element to prevent movement relative to the one component in the direction opposite the wear take-up direction.

Through the use of a wedge-type clamp element or a rolling clamp element, it is possible in a simple and reliable manner to generate a clamping action which prevents the take-up element from moving in the direction opposite the wear take-up direction. During movement in the allowed direction, that is, in the wear take-up direction, the clamping element can move in a rolling and/or sliding manner along the surface of the take-up element, so that essentially no resistance is offered to this movement.

To ensure that even very small movements of the take-up element in the direction opposite the wear take-up direction can be prevented, the minimum of one clamping element is preloaded with clamping contact against the take-up element.

The minimum of one clamping element can be a ball. Alternatively, a roller can be used as a clamping element, which is advantageous in particular because of the lower load per unit area during the interaction between it and the take-up element.

To ensure that the minimum of one clamping element exerts a defined load on the take-up element, it is possible, for example, to assign a support surface, which extends along one side of the take-up element and which is angled in the wear take-up direction, to the minimum of one clamping element.

It is advantageous to provide the clamping element with a preloading element, which preloads the clamping element against the support surface. The preloading direction is preferably essentially opposite the wear take-up direction.

To avoid loads acting on the take-up element transversely to the wear take-up direction, at least one clamping element can be provided on each of the two opposite sides of the take-up element.

To avoid any impairment to the functionality of the anti-reset arrangement, especially those caused by dirt, at least one clamping element can be enclosed by a housing.

The minimum of one take-up element preloaded to move in the wear take-up direction can be a take-up ring, which can rotate around the axis of rotation with respect to the one component. This adjusting ring can have, for example, one or more ramp surface areas, each of which can slide along a ramp surface area which is stationary with respect to the one component.

This one component can be, for example, the pressure plate.

So that the wear which has occurred in the inventive pressure plate assembly can be detected easily and reliably, at least one play sensor arrangement can be provided to detect the wear, where the minimum of one play sensor arrangement includes a detection element, which is or can be brought into interaction with another component which, upon the occurrence of wear, can shift position with respect to the one component so that wear can be detected, the detection element thus being brought by means of this interaction into a position with respect to the one component which corresponds to the amount of wear.

To ensure that the detection element does not return to its original position again after the detection of wear, that is, after it has moved with respect to the one component during the execution of a clutch-release operation, for example, an arresting element can be provided, by means of which the detection element can be arrested in its position with respect to the one component, i.e., in the position which corresponds to the amount of wear.

A blocking element, which prevents the take-up element from moving in the wear take-up direction, can be assigned to the minimum of one take-up element preloaded to move in the wear take-up direction to ensure that this take-up element is basically prevented from moving except when in fact a take-up operation is to be performed. This blocking element can be provided on the arresting element, for example.

It is also possible for the arresting element to comprise a wedge-like arresting slider, which engages between the detection element and the one component and which is preloaded to move in the wear take-up direction.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows an axial cross section through a pressure plate assembly with a wear take-up function;

FIG. 2 shows an axial view of the pressure plate provided in the pressure plate assembly of FIG. 1, looking in direction 11 in FIG. 1; and

FIG. 3 shows a magnified view of the detail in circle III in FIG. 2.

### DETAILED DESCRIPTION OF THE PRESENTLY PREFERRED EMBODIMENTS

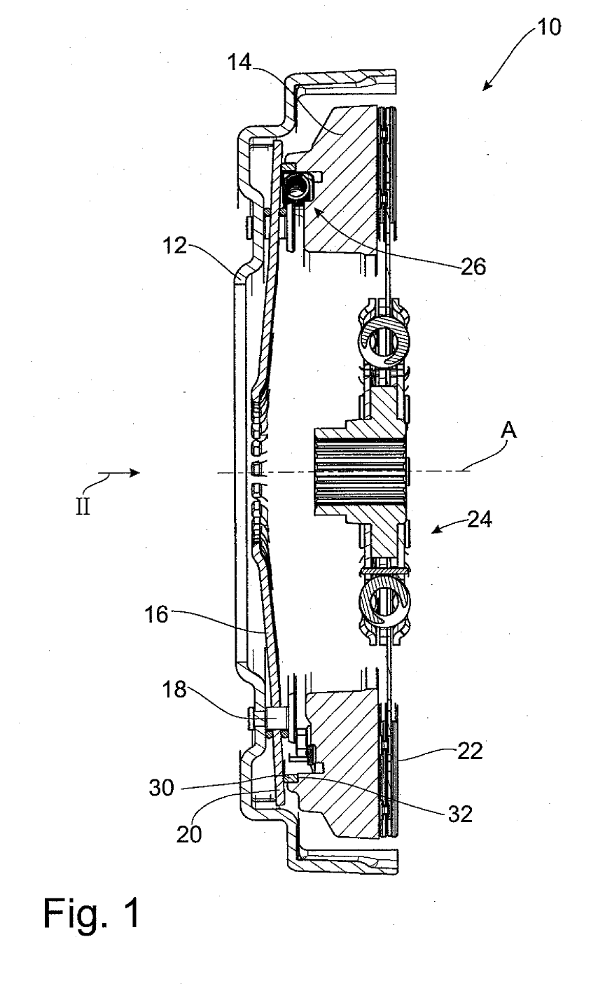

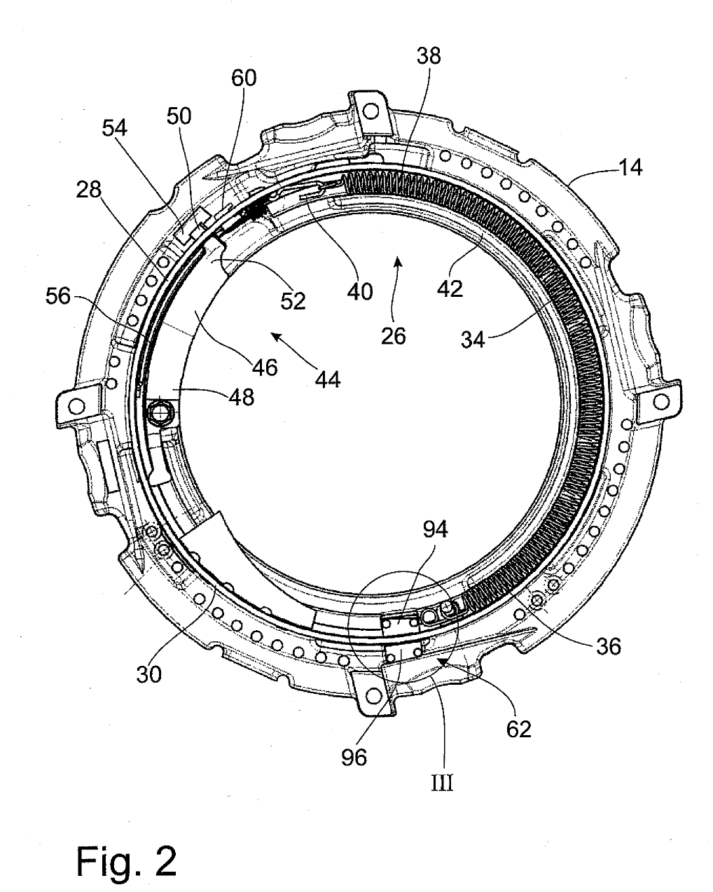

FIGS. 1 and 2 show a first embodiment of an inventive pressure plate assembly 10 for a friction clutch. This pressure plate assembly 10 comprises an essentially cup-like housing 12, in which a pressure plate 14 is supported by a plurality of tangential leaf springs (not shown) or the like so that it has essentially no freedom to rotate but is free to move in the same direction as that in which the axis of rotation A extends.

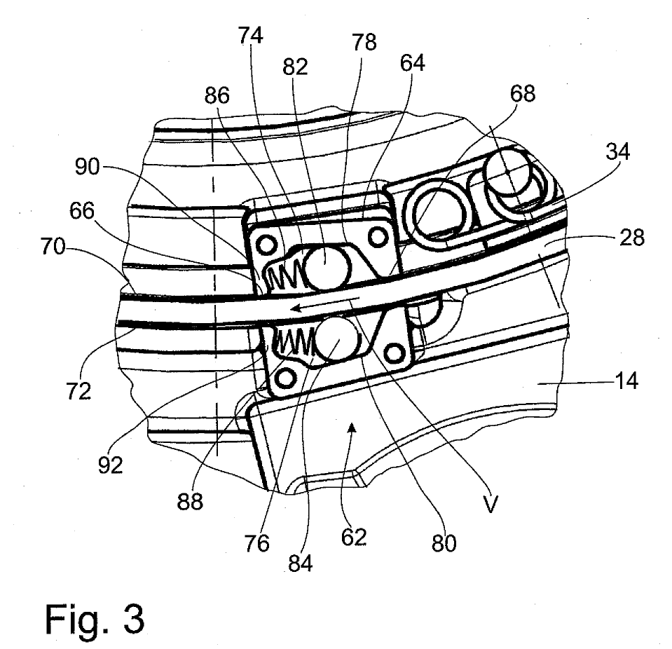

In the example shown here of a “push” type clutch, an energy-storage device 16 designed as a diaphragm spring is supported in its radially middle area against the housing 12 by a plurality of spacer bolts 18, whereas its radially outer area 20 acts on the pressure plate 14, thus pushing it against the friction linings 22 of a clutch disk 24. The energy-storage device 16 exerts force on the pressure plate 14 by way of a wear take-up device 26, the design of which will be explained in detail below with additional reference to FIGS. 2-3.

As its basic component, the wear take-up device 26 has a take-up ring 28, acting as the take-up element. On the axial side 30 facing away from the pressure plate 14, the take-up ring 28 is subjected to the force from the energy-storage device 16. On the side 32 facing the pressure plate 14, the take-up ring 28 has a plurality of ramp surface areas extending in the circumferential direction, which rest on corresponding ramp surface areas of the pressure plate 14. These ramp surface areas are at a predetermined angle to a plane orthogonal to the axis of rotation A, so that a rotation of the take-up ring 28 around the axis of rotation A relative to the pressure plate 14 causes the side 30 immediately adjacent to the energy-storage device 16 to shift position axially with respect to the pressure plate 16—specifically, to move farther away from the pressure plate. The angle of the ramp surface areas in contact with each other thus determines the axial displacement per unit angle of rotation.

One of the circumferential ends 36 of a helical tension spring 34, acting as a preloading element for the take-up ring, is fastened to the pressure plate 14. This spring extends radially inside and along the take-up ring 28. The other end 38 of the spring is fastened to the take-up ring 28 by means of, for example, a hook-like connecting element 40. Because it is installed with preload, the spring thus tries to rotate the take-up ring 28 with respect to the pressure plate—in FIG. 2, this would be rotation in the clockwise direction. The direction in which the take-up ring 28 rotates versus the pressure plate 14 also defines the wear take-up direction. To ensure that the helical tension spring 34 retains its curved configuration along the inside surface of the take-up ring 28, several retaining areas 42 can be provided on the pressure plate 14, against which the radially inner side of the helical tension spring 34 can rest.

So that the wear which occurs in a friction clutch as a result of, for example, the wearing-down of the friction linings 22 can be detected, a play sensor arrangement 44 with a detection element 46 designed as a leaf spring is provided. One of the circumferential ends of this element is fastened to the pressure plate 14 and, in the example shown here, the element extends in the circumferential direction along the radially inside surface of the take-up ring 28. A detection section 50 at its other end area 52 passes radially outward through an opening in the take-up ring 28 and overlaps radially a stop 54, permanently attached to the housing 12, for example. When the pressure plate 14 and thus also the detection element 46 move in the axial direction, the detection section 50 also moves with respect to the stop 54. Because this stop 54 is located axially between the pressure plate 14 and the detection section 50, the detection section 50 will approach the stop 54 when the pressure plate 14 is moved toward the friction linings 22 to produce engagement. As long as no wear has occurred, essentially no contact will occur between the detection section 50 and the stop 54. Only after the thickness of the friction linings 52 has decreased and the pressure plate 14 must therefore move farther with respect to the housing 12 than is the case before wear has occurred, will the detection section 50 make contact with the stop 54 and thus will no longer be able to follow along with the pressure plate 14 as the plate moves by increasingly greater amounts. This means that the end 52 with the detection section 50 will shift axially with respect to the pressure plate 14; that is, it will move away from it to an extent which corresponds to the amount of wear which has occurred.

In the example shown here, an arresting element 56 designed as a wedge-like slider also extends in the circumferential direction radially inside the take-up ring 28 and is positioned in such a way that it lies between the detection element 50 and the pressure plate 14. A helical tension spring 58 acting as a preloading element for this arresting slider 56 acts on the arresting slider 56 and is also fastened to the take-up ring 28 or to the connecting element 40. This helical tension spring 58 tries to pull the wedge-like arresting slider 56 into the intermediate space formed between the pressure plate 14 and the detection section 50. When, as a result of wear, the pressure plate moves excessively with respect to the housing 12 and the detection section 50 cannot continue to follow this movement, the preloading effect of the helical tension spring 58 will cause the arresting slider 56 to move into the increasingly larger intermediate space between the pressure plate 14 and the detection section 50.

A blocking section 60, which engages radially from the inside in an associated opening in the take-up ring 28 with a certain amount of play in the circumferential direction, is provided on the arresting slider 56. In this way, it is possible, upon the occurrence of wear, for the arresting slider 56 to move in the circumferential direction without being blocked by the take-up ring 28. When, after an event of this type, which can be referred to essentially as a “detection event”, the friction clutch equipped with this type of pressure plate assembly 10 is disengaged again and therefore the radially outer part of the energy-storage device 16 moves away from the friction linings 22, the load on the take-up ring 28 is also reduced. Because this ring is under the preloading effect of the helical tension spring 34 and because the blocking section 60 has moved in the circumferential direction versus the take-up ring 28 as a result of the previously performed detection event, in this state the take-up ring is free to move in the circumferential direction as shown in FIG. 2, that is, in the wear take-up direction, and can continue to move in this direction until it makes contact again with the blocking section 60. Because this blocking section 60 is provided on the arresting slider 56 and the arresting slider 56 is clamped between the detection section 50 and the pressure plate 14, a blocking effect is therefore produced, which ensures that the take-up ring 28 can move in the circumferential direction only by an amount which corresponds to the wear previously detected on the basis of the relative movement of the detection section 50 versus the pressure plate 14.

External influences such as vibrations, impacts, etc., which act on the pressure plate assembly 10 can have the effect of moving the take-up ring 28 at least slightly back in the circumferential direction in opposition to the preloading force of the helical tension spring 34, i.e., in the direction opposite the wear take-up direction, especially when the energy-storage device 16 is not exerting any force on the pressure plate 14. This would lead to a completely undefined, at least partial reversal of a previously completed wear take-up process. To prevent this, an anti-reset arrangement 62 is provided on the pressure plate assembly 10. This arrangement is explained in the following on the basis of FIG. 3.

FIG. 3 shows on an enlarged scale the anti-reset arrangement 62 and its interaction with the take-up ring 28. We can see, for example, a housing 64, attached by screws before the take-up ring 28 is mounted on the pressure plate 14. The take-up ring 28 passes through the approximate center, seen in the radial direction, of the housing 64, and for this purpose the housing has two openings 66, 68, which correspond, for example, to the radial thickness of the take-up ring. On both sides 70, 72 of the take-up ring 28, a recess 74, 76, each of which is open toward the take-up ring 28, is provided in the housing 64. In the end areas opposite the wear take-up direction “V”, i.e., at the radial end areas, each of the two recesses 74, 76 is limited by a support surface 78, 80, which extends radially from the inside in the one case and from the outside in the other case toward the associated side 70, 72 of the take-up ring 28 in the direction opposite the wear take-up direction V, that is, at an angle to a radial line.

A rolling clamp element 82, 84, designed as a roller, for example, is held in each of the recesses 74, 76. These rollers are oriented in such a way that their longitudinal axes and thus their axes of rotation are essentially parallel to the axis of rotation A and thus also perpendicular to the wear take-up direction V. Each of these rolling clamp elements 82, 84 is provided with a helical compression spring 86, 88, acting as a preloading element. These springs are supported at one end against the rolling clamp elements 82, 84 and at the other against the wall 90, 92 forming the boundary of the recess 74, 76 in the wear take-up direction V. The preloading force exerted by the helical compression springs 86, 88 acts in a direction essentially opposite the wear take-up direction V and presses the associated rolling clamp element 82, 84 against the associated support surface 78, 80. Because these support surfaces 78, 80 are at an angle to the wear take-up direction V and thus to a radial line and extend along their associated sides 70, 72 of the take-up ring 28, the rolling clamp elements 82, 84 are pressed radially outward in the one case and radially inward in the other case onto their associated sides 70, 72 of the take-up ring 28.

When the take-up ring 28 moves in the wear take-up direction V to implement a wear take-up process as explained above, it carries along, at least slightly, the rolling clamp elements 82, 84 in the wear take-up direction V as a result of frictional interaction and the opportunity now given the rollers to roll. Because the rolling clamp elements are moved in a direction in which the applied forces generated by the support surfaces 78, 80 against the sides 70, 72 are also reduced, the take-up ring 28 can be moved essentially without hindrance. This is supported by the fact that the helical compression springs 86, 88 are installed in such a way and therefore exert their preloading forces in such a way that these forces are directed basically away from the associated sides 70, 72 of the take-up ring 28 and toward the associated support surfaces 78, 80. The helical compression springs 86, 88 therefore do not themselves exert any forces which would act to press the rolling clamp elements directly against the sides 70, 72.

If, however, force components occur which try to move the take-up ring 28 in the direction opposite the wear take-up direction V, the ring will, again through frictional interaction, carry the rolling clamping elements 82, 84 at least slightly along in the direction opposite the wear take-up direction V or will at least attempt to carry them along, which has the result that, in addition to the preloading forces generated by the helical compression springs 86, 88, the rolling clamp elements 82, 84 will be pressed more strongly against the support surfaces 78, 80 and by these in turn more strongly against the sides 70, 72 of the take-up ring 28. Here, therefore, a self-locking mechanism is provided, which becomes even more effective as the force trying to move the take-up element 28 in the direction opposite the wear take-up direction increases.

So that contamination cannot interfere with the rolling clamp elements or with their function, the housing 64 can be closed off on both sides of the take-up ring 28 by cover plates 94, 96, so that it is essentially impossible for dirt to intrude into the recesses 74, 76.

It should be pointed out that a wide variety of departures from the design principles described above are possible. For example, a rolling clamp element of the type in question can be provided only on the radially outer side 72 or only on the radially inner side 70. The arrangement shown here, however, in which a rolling clamp element is present on both sides and also in the same circumferential area is advantageous because of the uniform load and the avoidance of radial forces on the take-up ring. It would also be possible, of course, to use rolling elements different from the rollers discussed here; for example, balls could be used. The helical compression springs 86, 88 acting as preloading elements could also be replaced by other preloading elements such as elastomeric blocks, etc. It would also be possible to make many different changes in the area of the wear take-up device 28. For example, two take-up rings could be provided, one of which is able to move in the circumferential direction, whereas the other is held in place with respect to the pressure plate. It would also be possible to use the detection element 46 to block the movement of the essentially movable ring directly.

In place of the rolling clamp elements shown in FIG. 3, it would also be possible to use wedge-like clamping elements, which cannot roll along the associated side of the take-up ring but which rather, because of their wedge-like shape and their contact with the associated support surfaces and the frictional interaction with the take-up ring, are pressed more strongly against the take-up ring when the take-up ring tries to move in the direction opposite the wear take-up direction. When this clamping action is produced, these wedge-like clamping elements then act in a manner similar to the previously described rolling clamp elements, which ultimately are also wedged between the support surface and the associated side of the take-up ring when the take-up ring is subjected to a force which tries to move it in the he direction opposite the wear take-up direction.

The invention is not limited by the embodiments described above which are presented as examples only but can be modified in various ways within the scope of protection defined by the appended patent claims.

We claim:

1. A pressure plate assembly for a friction clutch with automatic wear compensation, the assembly comprising:
a housing which can be attached to a flywheel for rotation in common about an axis of rotation;
a pressure plate installed in the housing essentially without freedom of rotation but movable axially with respect to the housing;
an energy storage device supported against the housing and the pressure plate and exerting a force along a support path between the energy storage device and one of the housing and the pressure plate;
a wear take-up device installed in the support path, the wear take-up device comprising a wear take-up element which is preloaded to move in a wear take-up direction; and
an anti-reset device comprising at least one clamping element which can be blocked to generate clamping contact with the wear take-up element to prevent movement of the wear take-up element relative to said one of the housing and the pressure plate in a direction opposite to the wear take-up direction.

2. The pressure plate assembly of claim 1 further comprising means for preloading said at least one clamping element into clamping contact with the wear take-up element.

3. The pressure plate assembly of claim 1 wherein said at least one clamping element is a roller.

4. The pressure plate assembly of claim 1 wherein said at least one clamping element is a ball.

5. The pressure plate assembly of claim 1 further comprising a support surface assigned to each said at least one clamping element, the support surface lying adjacent to the take-up element at an acute angle to the wear take-up direction.

6. The pressure plate assembly of claim 5 further comprising a preloading element loading each said clamping element against a respective said support surface.

7. The pressure plate assembly of claim 6 wherein each said clamping element is preloaded in a direction opposite to the wear take-up direction.

8. The pressure plate assembly of claim 1 wherein at least one said clamping element is provided on each of two opposing sides of said wear take-up element.

9. The pressure plate assembly of claim 1 wherein the anti-reset device further comprises a housing containing the at least one clamping element.

10. The pressure plate assembly of claim 1 wherein the wear take-up element is a take-up ring which can rotate around the axis of rotation with respect to said one of the housing and the pressure plate.

11. The pressure plate assembly of claim 1 wherein said one of the housing and the pressure plate is the pressure plate.

12. The pressure plate assembly of claim 1 further comprising at least one play sensor arrangement which detects wear, said play sensor arrangement comprising:
a stop which can shift position with respect to said one of said housing and said pressure plate when said friction clutch incurs wear; and
a detection element comes into contact with the stop at a position relative to said one of said housing and said pressure plate at a position which corresponds to the wear.

13. The pressure plate assembly of claim 12 further comprising a blocking element which can block the wear take-up element from moving in the wear take-up direction.

14. The pressure plate assembly of claim 12 further comprising an arresting element which arrests the detection element at the position which corresponds to the wear.

15. The pressure plate assembly of claim 13 further comprising a blocking element which can block the wear take-up element from moving in the wear take-up direction, wherein the blocking element is provided on the arresting element.

16. The pressure plate assembly of claim 14 wherein the arresting element comprises a wedge-like arresting slider which engages between the detection element and said one of said housing and said pressure plate, wherein said arresting slider is preloaded to move in the wear take-up direction.
